(19) United States
(12) Patent Application Publication
(10) Pub. No.: US 2004/0000740 A1
(43) Pub. Date: Jan. 1, 2004

(54) Process of manufacturing of shoes insole

(76) Inventor: Cheng-Te Chi, Taipei (TW)

Correspondence Address: Cheng-Te CHI, PO Box 82-144, TAIPEI, TW

(21) Appl. No.: 10/179,991

(22) Filed: Jun. 26, 2002

(51) Int. Cl. B29C 31/00

(52) U.S. Cl. 264/157; 264/175; 264/320

(57) ABSTRACT

A process of manufacturing of shoes insole is disclosed. In the present method, a high-density thermoplastic material and a low density thermoplastic material are undergone a rolling process of the rollers of the pressing machine. The top and the bottom of the materials are together pressed with plastic woven cloth and non-woven cloth such that a layer of dual density rubber board is adhered in between the plastic woven cloth and the non-woven cloth to form into an integrally formed dual density complex rubber board. The present process reduces the fabrication time and the production cost is reduced as the capital for equipments is greatly reduced. The present invention also allows the lowering of cost for shoes insole.

### BACKGROUND OF THE INVENTION

The present invention relates to a manufacturing process of shoes insole, and in particular, a process employing high density thermoplastic material and low density thermoplastic material and plastic foamed woven and non-woven cloth to form into a thermo pressed dual density complex rubber board.

### SUMMARY OF THE PRESENT INVENTION

Accordingly it is an object of the present invention to provide method of manufacturing shoes insole employing a high density thermoplastic material and a low density thermoplastic material being sent to a heated mold via a silo A and a silo B of a pressing device such that the materials are fused to form a layer with a long and flat dual density rubber board structure, characterized in that after the two materials are pressed by rollers of a pressing device, the top and bottom surface of the material are pressed together with a plastic foamed woven and a non-woven cloth to form a complex rubber board, a tailoring device cuts the dual density complex rubber board into a plurality of shoes insole blank, and the blank is then molded to form shoes insole.

Yet another object of the present invention is to provide a manufacturing process for shoes insole, when the high density thermoplastic material and the low density thermoplastic material are rolled and pressed, the top and bottom of the two layers of the nonwoven cloth are fused into a layer of dual density rubber board.

Again another object of the present invention is to provide a manufacturing process for shoes insole, wherein when the high density thermoplastic material and low density thermoplastic material are transported to the rollers for pressing, the non-woven cloth is also transported at the same time for pressing such that the top and bottom layers are fused to form a layer of dual density rubber board.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE PRESENT INVENTION

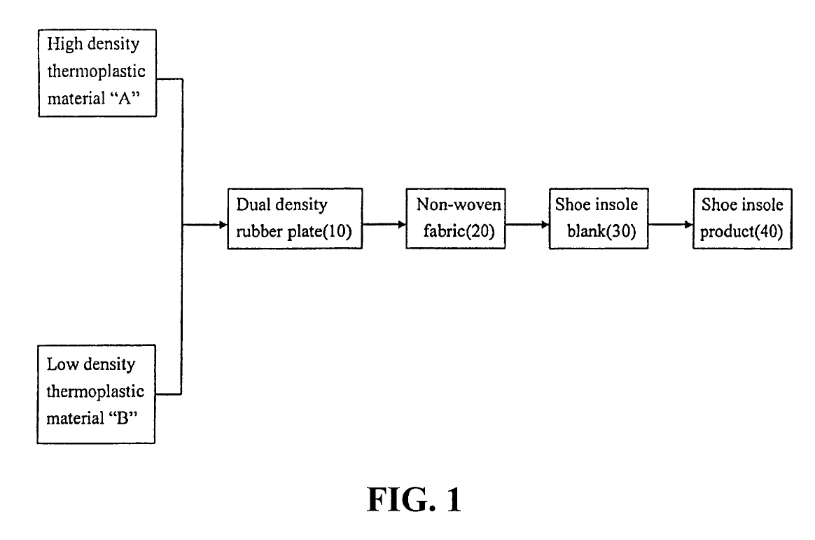

FIG. 1 is a flowchart showing a conventional manufacturing method disclosed in U.S. Pat. No. 6,338,768.

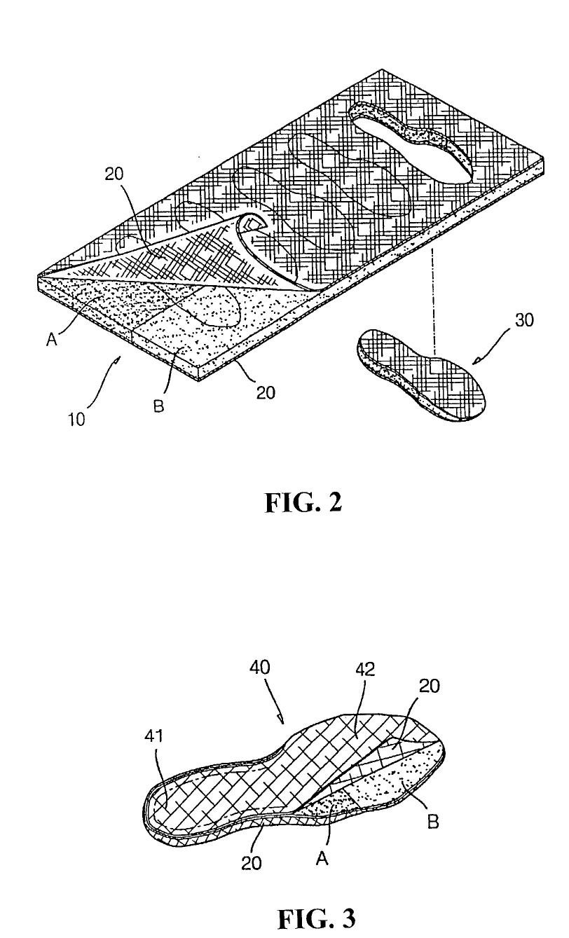

FIG. 2 is a schematic view showing the dual density thermoplastic material rubber board tailored to form blank for shoes insole in U.S. Pat. No. 6,338,768.

FIG. 3 is a perspective view of the insole according to U.S. Pat. No. 6,338,768.

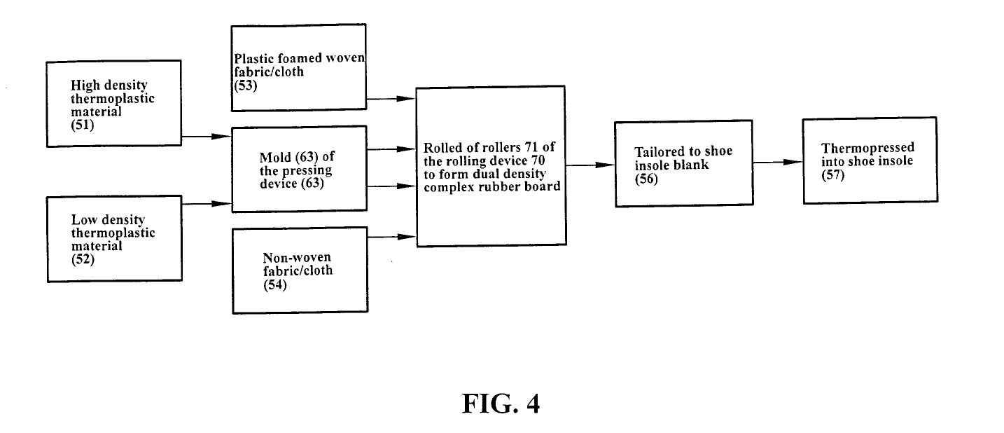

FIG. 4 is a manufacturing flowchart in accordance with the present invention.

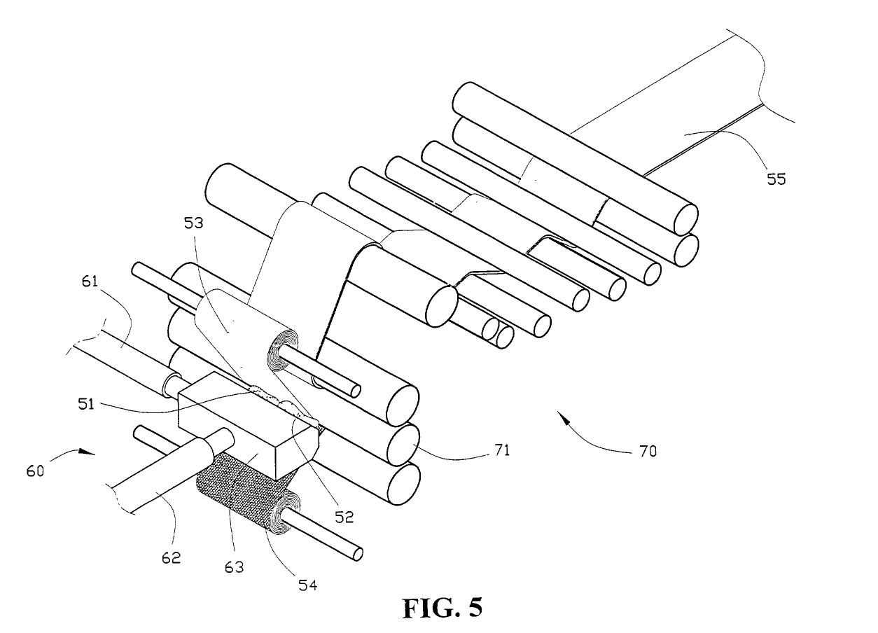

FIG. 5 is a perspective view showing the structure of the dual density complex rubber board in accordance with the present invention.

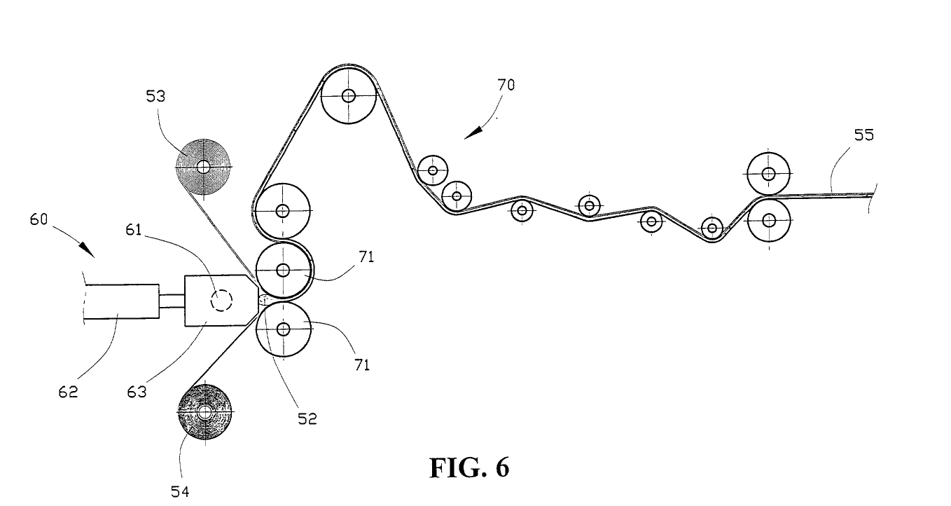

FIG. 6 is a side view of the dual density rubber board in accordance with the present invention.

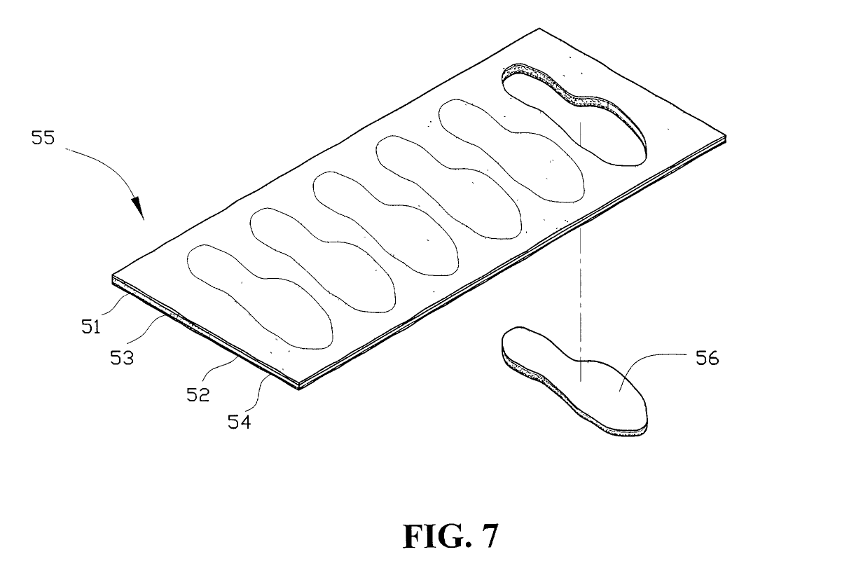

FIG. 7 is a shoe insole tailored on the dual density complex rubber board in accordance with the present invention.

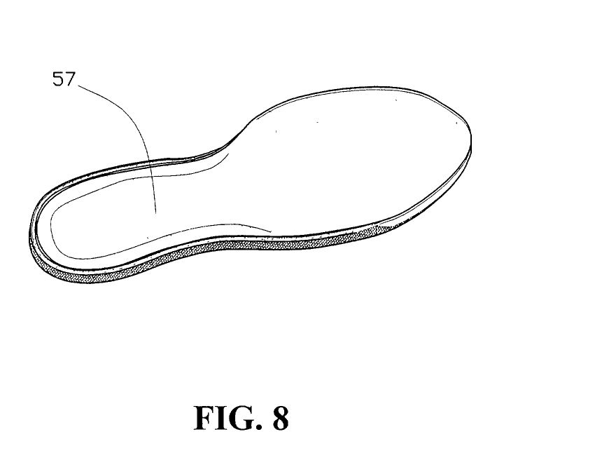

FIG. 8 is a schematic view of the shoes insole in accordance with the present invention.

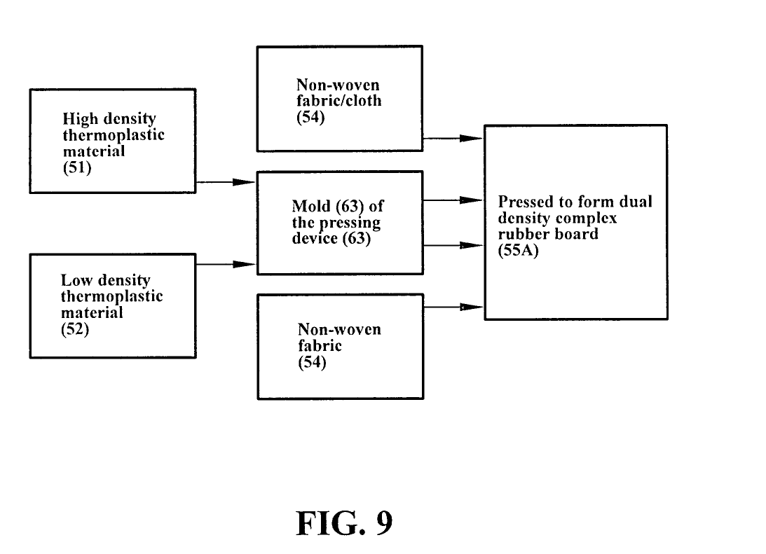

FIGS. 9 to 13 show manufacturing process of the 2 to 6 preferred embodiment in accordance with the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIGS. 4 to 8, there is shown a method of manufacturing shoes insole, wherein the method employs a high density thermoplastic material 51 and a low density thermoplastic material 52 which are respectively fed into the silo A 61 and silo B 62 of a pressing device 60. These materials are then transported into a heated mold 63 such that the melted materials 51,52 are rolled and pressed by the rolling device 70 to form into a single layered long and flat dual density rubber board structure.

In accordance with the present invention, in the course of rolling and pressing, after the two materials 51, 52 are pressed by rollers 71 of the rolling device 70, the top and bottom surface of a foamed woven 53 and a non-woven cloth 54 are pressed and fused together to form a complex rubber board 55, a tailoring device cuts the complex rubber board 55 to form a shoes insole blank 56, and the blank 56 is then undergone a thermal pressing process to form a shoes insole 57 in accordance with the present invention.

Referring to FIG. 9, there is shown a second preferred embodiment in accordance with the present invention. When the high density thermoplastic material 51 and the low density thermoplastic material 52 are rolled and pressed, the top and bottom of the two layers of the nonwoven cloth 54 are fused into a layer of dual density rubber board 55A.

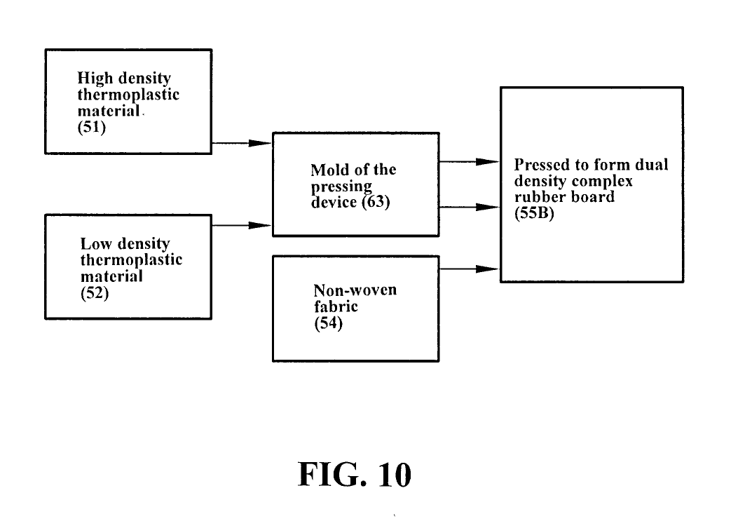

Referring to FIG. 10, there is shown a third preferred embodiment in accordance with the present invention. When the high density thermoplastic material 51 and the low density thermoplastic material 52 are rolled and pressed, the nonwoven cloth 54 is also transported and rolled, such that the top of the nonwowen cloth 54 is thermally fused with a layer of dual density rubber board and thus a layer of dual density rubber board 55B is formed in accordance with the present invention.

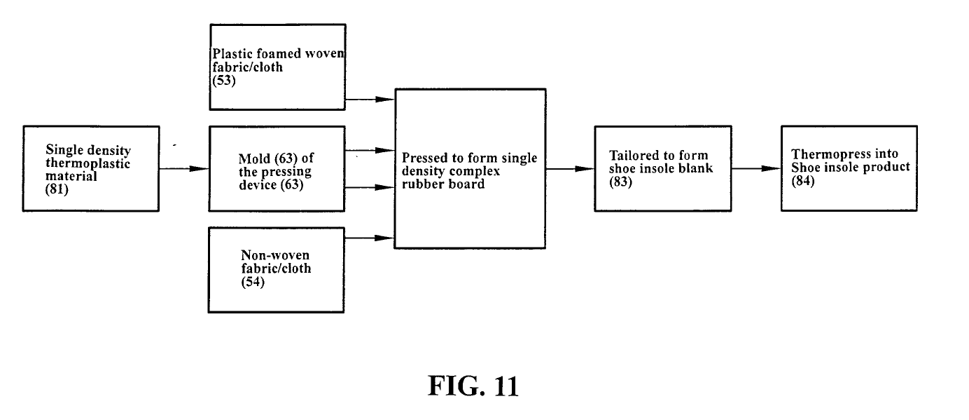

Referring to FIG. 11, there is shown a fourth preferred embodiment in accordance with the present invention. When a single density thermoplastic material 81 is transported into a heated mold 63 using a pressing device 60, the melted or fused single density thermoplastic material 81 is rolled and pressed into a long and flat rubber board structure, wherein the single density thermoplastic material 81 is transported to a heated mold 63 so that the melted thermoplastic material 81 is pressed by the rollers 71 of the rolling device 70 to form long and flat rubber board structure and the foamed woven cloth 53 and the non-woven cloth 54 are fused to form into a layer of single density complex rubber board 82, and a tailoring device cuts the complex rubber board 82 into a plurality of shoes insole blank 83, and the blank 83 is thermo pressed to form shoes insole 84.

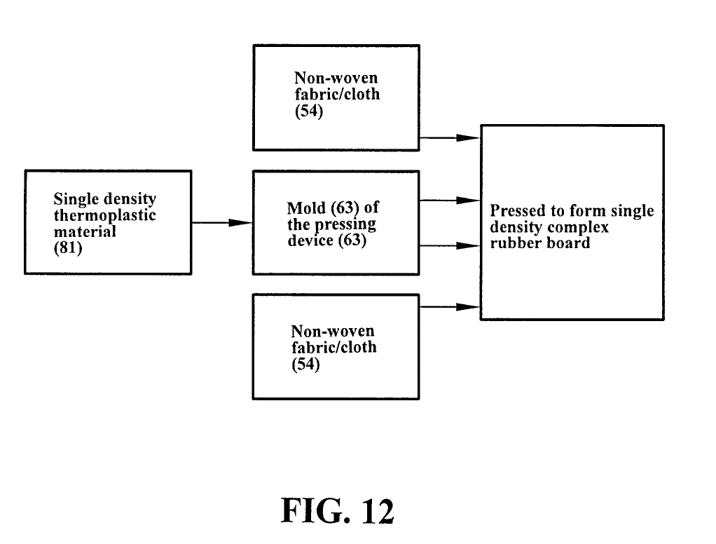

Referring to FIG. 12, there is shown a fifth preferred embodiment in accordance with the present invention. When the single density thermoplastic material 81 is transported to a mold 63 using a pressing device 60 to the rollers 71 of a rolling device 70, the top and bottom layer are at the same time transport the nonwoven cloth 54 for rolling, such that the nonwoven cloth 54 is thermally adhered a layer of rubber board and formed into a single density complex rubber board 82A.

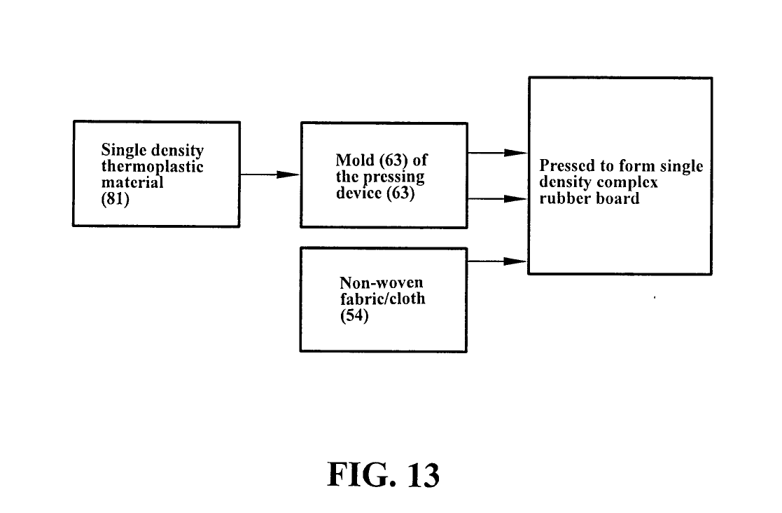

As shown in FIG. 13, there is shown a sixth preferred embodiment in accordance with the present invention. When the single density thermoplastic material 81 is transported to a mold 63 using a pressing device 60 to the mold 63, and via the rollers 71 of a rolling device 70 for rolling, the bottom of the device is at the same time transport the nonwoven cloth 54 for rolling, such that top of the nonwoven cloth 54 is thermally adhered a layer of rubber board and formed into a single density complex rubber board 82B.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of manufacturing shoes insole employing a high density thermoplastic material and a low density thermoplastic material being sent to a heated mold via a silo A and a silo B of a pressing device such that the materials are fused to form a layer with a long and flat dual density rubber board structure, characterized in that After the two materials are pressed by rollers of a pressing device, the top and bottom surface of the material are pressed together with a plastic foamed woven and a non-woven cloth to form a complex rubber board, a tailoring device cuts the dual density complex rubber board into a plurality of shoes insole blank, and the blank is then molded to form shoes insole.

2. The method of claim 1, wherein when the high density thermoplastic material and the low density thermoplastic material are rolled and pressed, the top and bottom of the two layers of the nonwoven cloth are fused into a layer of dual density rubber board.

3. The method of claim 1, wherein when the high density thermoplastic material and low density thermoplastic material are transported to the rollers for pressing, the non-woven cloth is also transported at the same time for pressing such that the top and bottom layers are fused to form a layer of dual density rubber board.

4. The method of claim 1, wherein the thermoplastic material is transported to a heated mold so that the melted thermoplastic material is pressed by the rollers of the pressing device to form long and flat rubber board structure and the foamed woven cloth and the non-woven cloth are fused to form into a layer of rubber board, and a tailoring device cuts the complex rubber board into a plurality of shoes insole blank, and the blank is thermo pressed to form shoes insole.

5. The method of claim 4, wherein when the high density thermoplastic material and the low density thermoplastic material are rolled and pressed, the top and bottom of the two layers of the nonwoven cloth are fused into a layer of dual density rubber board.

6. The method of claim 4, wherein when the high density thermoplastic material and low density thermoplastic material are transported to the rollers for pressing, the non-woven cloth is also transported at the same time for pressing such that the top and bottom layers are fused to form a layer of dual density rubber board.
